(19) United States
(12) Patent Application Publication
(10) Pub. No.: US 2015/0070747 A1
(43) Pub. Date: Mar. 12, 2015

(54) DISPLAY ELEMENT RESET USING POLARITY REVERSAL

(71) Applicant: QUALCOMM MEMS Technologies, Inc., San Diego, CA (US)

(72) Inventors: Edward Keat Leem Chan, San Diego, CA (US); Cheonhong Kim, San Diego, CA (US); Wilhelmus Johannes R. Van Lier, San Diego, CA (US); Bing Wen, Poway, CA (US); Chandra Shekar Reddy Tupelly, San Ramon, CA (US); Ningning Zhou, Fremont, CA (US); Richard Yeh, Sunnyvale, CA (US)

(73) Assignee: QUALCOMM MEMS Technologies, Inc., San Diego, CA (US)

(21) Appl. No.: 14/021,866

(22) Filed: Sep. 9, 2013

(51) Int. Cl. G02B 26/00

(52) U.S. Cl. CPC G02B 26/001
USPC 359/290

(57) ABSTRACT

This disclosure provides circuits and methods for resetting a movable element, such as a mirror of an interferometric modulator (IMOD), to a consistent starting point or reset position. In one example, a circuit may include three electrodes with a capacitor coupled between two of the electrodes. Additionally, the polarity of one of the electrodes may be configured to switch and reverse in polarity relative to another electrode. Accordingly, the movable element may be moved to a reset position.

### TECHNICAL FIELD

This disclosure relates to electromechanical systems and devices. More specifically, the disclosure relates to resetting a movable element in an electromechanical system device, such as a mirror in an interferometric modulator (IMOD), to a consistent starting point or reset position.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

In some implementations, the position of one plate in relation to another may reflect a specific wavelength of light. The plate may be moved to another position in order to reflect another wavelength of light.

### SUMMARY

The systems, methods and devices of this disclosure each have several innovative aspects, no single one of which is solely responsible for the desirable attributes disclosed herein.

One innovative aspect of the subject matter described in this disclosure can be implemented in a circuit including a first electrode associated with a first voltage source, a second electrode associated with a second voltage source, a movable element, and a third electrode coupled with the movable element. In such implementations, a first capacitance is defined between the first electrode and the third electrode, and a second capacitance is defined between the second electrode and the third electrode. A capacitor is coupled between the second electrode and the third electrode.

In some implementations, the circuit can include a dielectric that can be positioned between the first electrode and the third electrode.

In some implementations, the first voltage source and the second voltage source are configured to switch in polarity with reference to each other. In some implementations, the movable element can be configured to move towards the first electrode in response to the switch in polarity of the first voltage source.

In some implementations, an electric field associated with the first electrode and the third electrode changes direction responsive to the switch in polarity between the first voltage source and the second voltage source.

In some implementations, the second capacitance can be larger than the first capacitance.

In some implementations, the second capacitance can be defined by a capacitance of the capacitor in parallel with an equivalent series capacitance of one or both of a first air gap and a dielectric. The first capacitance can be defined by an equivalent series capacitance of one or both of a second air gap and the movable element.

In some implementations, the second capacitance can be defined by a capacitance of the capacitor in parallel with an equivalent series capacitance of one or both of a first air gap and the movable element. The first capacitance can be defined by an equivalent series capacitance of one or both of a second air gap and a dielectric.

In some implementations, the movable element can include the third electrode and a mirror. The third electrode on the movable element can be positioned closer to the first electrode than the positioning of the mirror to the first electrode.

Another innovative aspect of the subject matter described in this disclosure can be implemented in a method for moving a movable element to a reset position. In some implementations, the voltage source associated with an electrode can be switched in polarity. The planar surface of the movable element can move towards the electrode in response to the switch in polarity.

In some implementations, the movable element is moved to a reset position associated with a dielectric. In some implementations, the movable element can rest against the dielectric when in the reset position.

Another innovative aspect of the subject matter described in this disclosure can be implemented in a circuit for moving a movable element of an electromechanical systems (EMS) device. The circuit can include: means for switching the polarity of a voltage associated with an electrode, and means for consistently resetting the movable element of the EMS device to the same reset position. In some implementations, the reset position is associated with a dielectric. In some implementations, the movable element rests against the dielectric when in the reset position.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays, organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is an isometric view illustration depicting two adjacent interferometric modulator (IMOD) display elements in a series or array of display elements of an IMOD display device.

FIG. 2 is a system block diagram illustrating an electronic device incorporating an IMOD-based display including a three element by three element array of IMOD display elements.

FIGS. 3A and 3B are schematic exploded partial perspective views of a portion of an electromechanical systems (EMS) package including an array of EMS elements and a backplate.

FIG. 4 is an example of a system block diagram illustrating an electronic device incorporating an IMOD-based display.

FIG. 5 is a circuit schematic of an example of a three terminal IMOD.

FIG. 6A is a circuit schematic illustrating capacitances of elements of display unit 540 of the circuit schematic of FIG. 5.

FIG. 6B is a circuit schematic illustrating capacitances of the circuit schematic of FIG. 6A.

FIG. 7 is a timing diagram for the circuit schematic of FIG. 5.

FIG. 8A is an illustration of an example of a movable element in a first position.

FIG. 8B is an illustration of an example of a movable element in a reset position.

FIG. 8C is an illustration of an example of a movable element in a second position.

FIG. 9A is an illustration of electric fields in the circuit schematic of FIG. 5.

FIG. 9B is another illustration of electric fields in the circuit schematic of FIG. 5.

FIG. 10 is an example of another circuit schematic of a three terminal IMOD.

FIG. 11 is an example of another circuit schematic of a three terminal IMOD.

FIG. 12 is a flow diagram illustrating a method for moving a movable element to a reset position.

FIGS. 13A and 13B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Interoferometric modulator (IMOD) displays may include a movable element, such as a mirror, that can be positioned at various points in order to reflect light at a specific wavelength. Some implementations of the subject matter described in this disclosure include driving a single-mirror IMOD to a consistent starting point. For example, moving the movable element to a specific position to reflect light at a particular wavelength may be easier and/or more reliable if the starting point is about the same every time the movable element needs to be moved.

In some implementations, the movable element may be moved to a consistent starting point, or reset position, by changing the voltage difference between electrodes, and therefore, changing the electric fields associated with the IMOD. For example, creating a voltage difference between a first electrode and second electrode that is larger than the voltage difference between the second and a third electrode can create a stronger electric field associated with the first and second electrodes. Additionally, a voltage applied to the first electrode may be reversed in polarity to change the direction of the electric field. Accordingly, the electric field can pull the movable element to the reset position.

Particular implementations of the subject matter described in this disclosure can be implemented to realize one or more of the following potential advantages. Driving the movable element from a consistent starting point may improve precision of the movement of the mirror. Moreover, starting from a consistent starting point may eliminate the impact of hysteresis in the electromechanical response. For example, applying 5 Volts (V) to the movable element may move the movable element to a new position from an initial position. However, when the movable element starts from a different initial position, applying 5 V may move the movable element to a slightly different position. Additionally, returning the movable element to a consistent starting point can prevent the movable element from remaining in the same position for an extended period of time, and therefore, increase reliability.

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

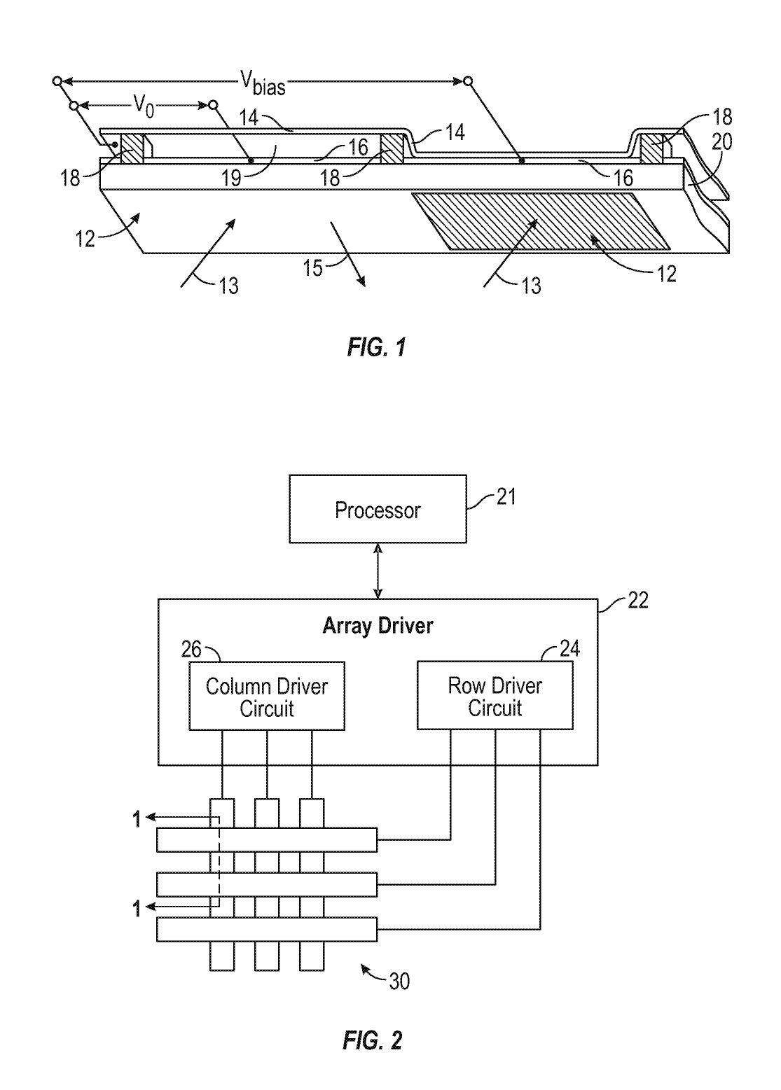

FIG. 1 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 1 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 1, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 1 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (A).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 1, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 1. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 is a system block diagram illustrating an electronic device incorporating an IMOD-based display including a three element by three element array of IMOD display elements. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example a display array or panel 30. The cross section of the IMOD display device illustrated in FIG. 1 is shown by the lines 1-1 in FIG. 2. Although FIG. 2 illustrates a 3×3 array of IMOD display elements for the sake of clarity, the display array 30 may contain a very large number of IMOD display elements, and may have a different number of IMOD display elements in rows than in columns, and vice versa.

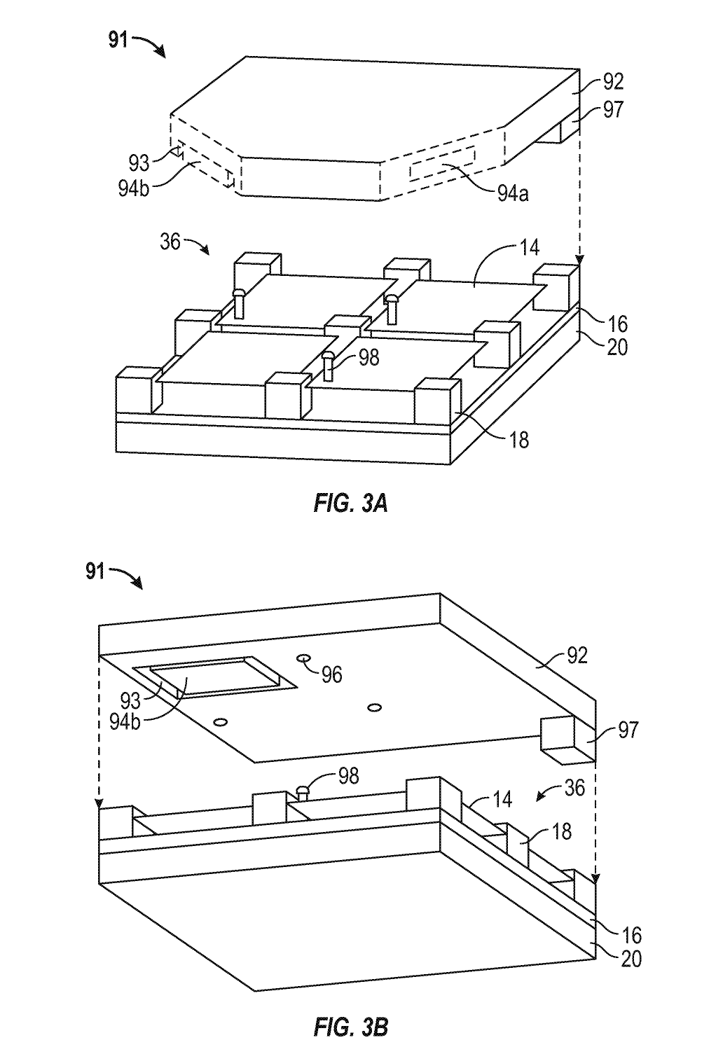

FIGS. 3A and 3B are schematic exploded partial perspective views of a portion of an EMS package 91 including an array 36 of EMS elements and a backplate 92. FIG. 6A is shown with two corners of the backplate 92 cut away to better illustrate certain portions of the backplate 92, while FIG. 6B is shown without the corners cut away. The EMS array 36 can include a substrate 20, support posts 18, and a movable layer 14. In some implementations, the EMS array 36 can include an array of IMOD display elements with one or more optical stack portions 16 on a transparent substrate, and the movable layer 14 can be implemented as a movable reflective layer.

The backplate 92 can be essentially planar or can have at least one contoured surface (e.g., the backplate 92 can be formed with recesses and/or protrusions). The backplate 92 may be made of any suitable material, whether transparent or opaque, conductive or insulating. Suitable materials for the backplate 92 include, but are not limited to, glass, plastic, ceramics, polymers, laminates, metals, metal foils, Kovar and plated Kovar.

As shown in FIGS. 6A and 6B, the backplate 92 can include one or more backplate components 94a and 94b, which can be partially or wholly embedded in the backplate 92. As can be seen in FIG. 6A, backplate component 94a is embedded in the backplate 92. As can be seen in FIGS. 6A and 6B, backplate component 94b is disposed within a recess 93 formed in a surface of the backplate 92. In some implementations, the backplate components 94a and/or 94b can protrude from a surface of the backplate 92. Although backplate component 94b is disposed on the side of the backplate 92 facing the substrate 20, in other implementations, the backplate components can be disposed on the opposite side of the backplate 92.

The backplate components 94a and/or 94b can include one or more active or passive electrical components, such as transistors, capacitors, inductors, resistors, diodes, switches, and/or integrated circuits (ICs) such as a packaged, standard or discrete IC. Other examples of backplate components that can be used in various implementations include antennas, batteries, and sensors such as electrical, touch, optical, or chemical sensors, or thin-film deposited devices.

In some implementations, the backplate components 94a and/or 94b can be in electrical communication with portions of the EMS array 36. Conductive structures such as traces, bumps, posts, or vias may be formed on one or both of the backplate 92 or the substrate 20 and may contact one another or other conductive components to form electrical connections between the EMS array 36 and the backplate components 94a and/or 94b. For example, FIG. 3B includes one or more conductive vias 96 on the backplate 92 which can be aligned with electrical contacts 98 extending upward from the movable layers 14 within the EMS array 36. In some implementations, the backplate 92 also can include one or more insulating layers that electrically insulate the backplate components 94a and/or 94b from other components of the EMS array 36. In some implementations in which the backplate 92 is formed from vapor-permeable materials, an interior surface of backplate 92 can be coated with a vapor barrier (not shown).

The backplate components 94a and 94b can include one or more desiccants which act to absorb any moisture that may enter the EMS package 91. In some implementations, a desiccant (or other moisture absorbing materials, such as a getter) may be provided separately from any other backplate components, for example as a sheet that is mounted to the backplate 92 (or in a recess formed therein) with adhesive. Alternatively, the desiccant may be integrated into the backplate 92. In some other implementations, the desiccant may be applied directly or indirectly over other backplate components, for example by spray-coating, screen printing, or any other suitable method.

In some implementations, the EMS array 36 and/or the backplate 92 can include mechanical standoffs 97 to maintain a distance between the backplate components and the display elements and thereby prevent mechanical interference between those components. In the implementation illustrated in FIGS. 3A and 3B, the mechanical standoffs 97 are formed as posts protruding from the backplate 92 in alignment with the support posts 18 of the EMS array 36. Alternatively or in addition, mechanical standoffs, such as rails or posts, can be provided along the edges of the EMS package 91.

Although not illustrated in FIGS. 3A and 3B, a seal can be provided which partially or completely encircles the EMS array 36. Together with the backplate 92 and the substrate 20, the seal can form a protective cavity enclosing the EMS array 36. The seal may be a semi-hermetic seal, such as a conventional epoxy-based adhesive. In some other implementations, the seal may be a hermetic seal, such as a thin film metal weld or a glass frit. In some other implementations, the seal may include polyisobutylene (PIB), polyurethane, liquid spin-on glass, solder, polymers, plastics, or other materials. In some implementations, a reinforced sealant can be used to form mechanical standoffs.

In alternate implementations, a seal ring may include an extension of either one or both of the backplate 92 or the substrate 20. For example, the seal ring may include a mechanical extension (not shown) of the backplate 92. In some implementations, the seal ring may include a separate member, such as an O-ring or other annular member.

In some implementations, the EMS array 36 and the backplate 92 are separately formed before being attached or coupled together. For example, the edge of the substrate 20 can be attached and sealed to the edge of the backplate 92 as discussed above. Alternatively, the EMS array 36 and the backplate 92 can be formed and joined together as the EMS package 91. In some other implementations, the EMS package 91 can be fabricated in any other suitable manner, such as by forming components of the backplate 92 over the EMS array 36 by deposition.

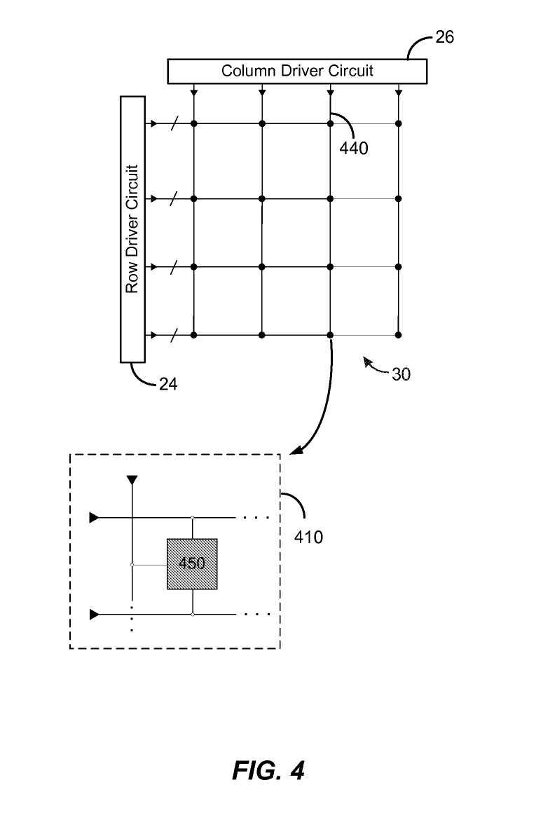

FIG. 4 is an example of a system block diagram illustrating an electronic device incorporating an IMOD display element. Moreover, FIG. 4 depicts an implementation of the row driver circuit 24 and the column driver circuit 26 of array driver 22 that provide signals to, for example the display array or panel 30, as previously discussed.

As an example, display module 450 in the fourth row may be provided a row signal and a common signal from row driver circuit 24. Display module 450 may also be provided a column signal from column driver circuit 26. The implementation of display module 450 may include a variety of different designs. In some implementations, display module 450 may include a transistor with its gate coupled to the row signal and the column signal provided to the drain. In an implementation, each display module 450 may include an IMOD display element. The common signal may provide a bias to other components within display module 450. In some implementations, display module 450 may have multiple common signals.

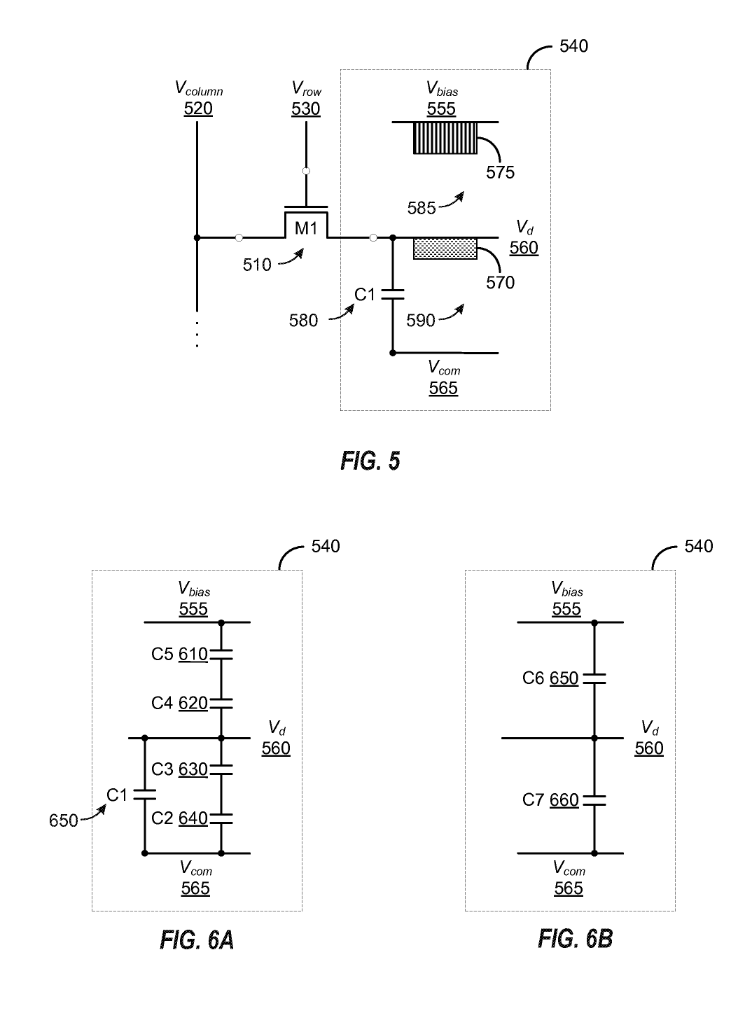

FIG. 5 is a circuit schematic of an example of a three terminal IMOD. In some implementations, the circuit of FIG. 5 may be display module 450 of FIG. 4. The circuit of FIG. 5 includes a switch implemented as an n-type metal oxide semiconductor (NMOS) transistor M1 510. The gate of transistor M1 510 is coupled to V_{row} 530, which may be provided by row driver circuit 24 of FIG. 4. Transistor M1 510 is also coupled to V_{column} 520, which may be provided by column driver circuit 26 of FIG. 4. The circuit of FIG. 5 also includes display unit 540.

In an implementation, display unit 540 may include three terminals or electrodes: V_{bias} 555, V_{d} 560, and V_{com} 565. Display unit 540 may also include movable element 570, dielectric 575, and capacitor 580. Movable element 570 may include a mirror. In the implementation of FIG. 5, capacitor 580 is coupled between V_{d} electrode 560 and V_{com} electrode 565. In another implementation, capacitor 580 may be coupled between V_{bias} electrode 555 and V_{d} electrode 560. Movable element 570 may be coupled with the V_{d} electrode 560. Additionally, in some implementations, air gap 585 may be between V_{bias} electrode 555 and V_{d} electrode 560. Air gap 590 may be between V_{d} electrode 560 and V_{com} electrode 565.

In some implementations, display unit 540 may include multiple capacitors. For example, instead of a single capacitor 580, multiple capacitors may be used.

FIG. 6A is a circuit schematic illustrating capacitances of elements of display unit 540 of the circuit schematic of FIG. 5. In FIG. 6A, capacitance C1 650 is associated with capacitor 580 of FIG. 5. Capacitance C5 610 is associated with dielectric 575. Capacitance C4 620 is associated with air gap 585. Capacitance C3 630 is associated with movable element 570. Capacitance C2 640 is associated with air gap 590.

FIG. 6B is a circuit schematic illustrating capacitances of the circuit schematic of FIG. 6A. FIG. 6B shows the equivalent capacitances between the electrodes. In FIG. 6B, capacitance C6 650 is the equivalent series capacitance of capacitance C5 610 (i.e., the capacitance associated with dielectric 575) and capacitance C4 620 (i.e., the capacitance associated with air gap 585). That is, capacitance C6 650 is the capacitance between V_{bias} electrode 555 and V_{d} electrode 560. Capacitance C7 660 is the equivalent capacitance of capacitance C1 650 (i.e., the capacitance associated with capacitor 580) in parallel with the equivalent series capacitance of capacitance C3 630 (i.e., the capacitance associated with the movable element) and capacitance C2 640 (i.e., the capacitance associated with air gap 590). That is, capacitance C7 660 is the capacitance between V_{d} electrode 560 and V_{com} electrode 565. Accordingly, when transistor M1 510 is turned off (i.e., V_{row} is biased to turn transistor M1 510 off), the model of capacitances of display unit 540 in FIG. 6B acts as a capacitor divider, and therefore, the voltage on V_{d} electrode 560 is determined by the change in V_{bias} electrode 555 and V_{com} electrode 565, and the capacitances of C6 650 and C7 660. In some implementations, if capacitance C1 650 (i.e., the capacitance associated with capacitor 580) is larger compared to the other capacitances, then capacitance C7 660 may be larger than capacitance C6 660. If capacitance C7 660 is sufficiently larger than capacitance C6 650 then the voltage associated with V_{d} electrode 560 may remain relatively constant, or slightly change, despite a voltage associated with another electrode changing, for example, V_{bias} electrode 555. As an example, the capacitance C1 650 may be approximately 50 to 200 femtofarads (fF) and the remaining capacitances may range from approximately 10 to 200 fF.

In some implementations, air gap 585 or air gap 590 may not be present. For example, as discussed later herein, movable element 570 may be configured to move towards an electrode and rest against a dielectric. Accordingly, air gaps 585 and 590 are variable, and may disappear, or reduce in size, in some implementations. Therefore, capacitance C6 650 or capacitance C7 660 may not include capacitances for air gap 585 or air gap 590, respectively.

In an implementation, the voltages applied to V_{bias} electrode 555 and V_{com} electrode 565 may be biased such that movable element 570 may be moved. For example, in one implementation, movable element 570 may be pulled by an electric field towards V_{bias} electrode 555 or V_{com} electrode 565 to a consistent starting point or reset position. In another implementation, movable element 570 may be pulled to rest against dielectric 575 to provide a consistent starting point or reset position.

In particular, the direction of the electric fields induced by external biases associated with V_{bias} electrode 555 and/or V_{com} electrode 565 may be switched by reversing the polarity of V_{bias} electrode 555 and/or V_{com} electrode 565. A change in voltage on V_{bias} electrode 555 and/or V_{com} electrode 565 may change the voltage difference between V_{bias} electrode 555 and V_{com} electrode 565 with V_{d} electrode 560. A larger voltage difference can provide a larger electric field which can move movable element 570. Therefore, adjusting the biases may move movable element 570 to a consistent starting or reset position before moving movable element 570 to a new position to provide color at a different wavelength.

For example, V_{bias} electrode 555 may be biased at 3 V and V_{com} electrode 565 may be biased at 0 V. Transistor M1 510 may be turned off, and therefore, V_{d} electrode 560 may be floating, for example, at a positive voltage previously applied while transistor M1 510 was turned on, such as 2 V. To reverse the polarity of V_{bias} electrode 555 in relation to V_{com} electrode 565, the voltage bias of V_{bias} electrode 555 may be switched to −3 V and the voltage bias of V_{com} electrode 565 may remain at 0 V. If capacitance C7 660 (i.e., the capacitance between V_{d} electrode 560 and V_{com} electrode 565) is sufficiently larger than capacitance C6 650 (i.e., the capacitance between V_{bias} electrode 555 and V_{d} electrode 560), then the voltage at V_{d} electrode 560 may be held relatively constant (e.g., remain at approximately 2 V), and therefore, the voltage difference between V_{d} electrode 560 and V_{com} electrode 565 is relatively unchanged (i.e., approximately 2 V difference between 2 V for V_{d} electrode 560 and 0 V for V_{com} electrode 565). However, the voltage difference between V_{bias} electrode 555 and V_{d} electrode 560 is larger because though V_{d} electrode 560 stays relatively constant, or only slightly changes, the bias of the power supply associated with V_{bias} electrode 555 has switched to −3 V. Accordingly, the electric field between V_{d} electrode 560 and V_{bias} electrode 555 is larger than the electric field between V_{d} electrode 560 and V_{com} electrode 565. Additionally, the direction of the electric field between V_{d} electrode 560 and V_{bias} electrode 555 has switched because V_{bias} electrode 555 switched from 3 V to −3 V. Therefore, movable element 570 may be pulled up because the electric field between V_{d} electrode 560 and V_{bias} electrode 555 is larger and in the opposite direction of the electric field between V_{d} electrode 560 and V_{com} electrode 565. In some implementations, movable element 570 may be pulled up, and rest against, dielectric 575. That is, dielectric 575 may act as a “stop” for movable element 570, and therefore, provide a reset position or consistent starting point for movable element 570.

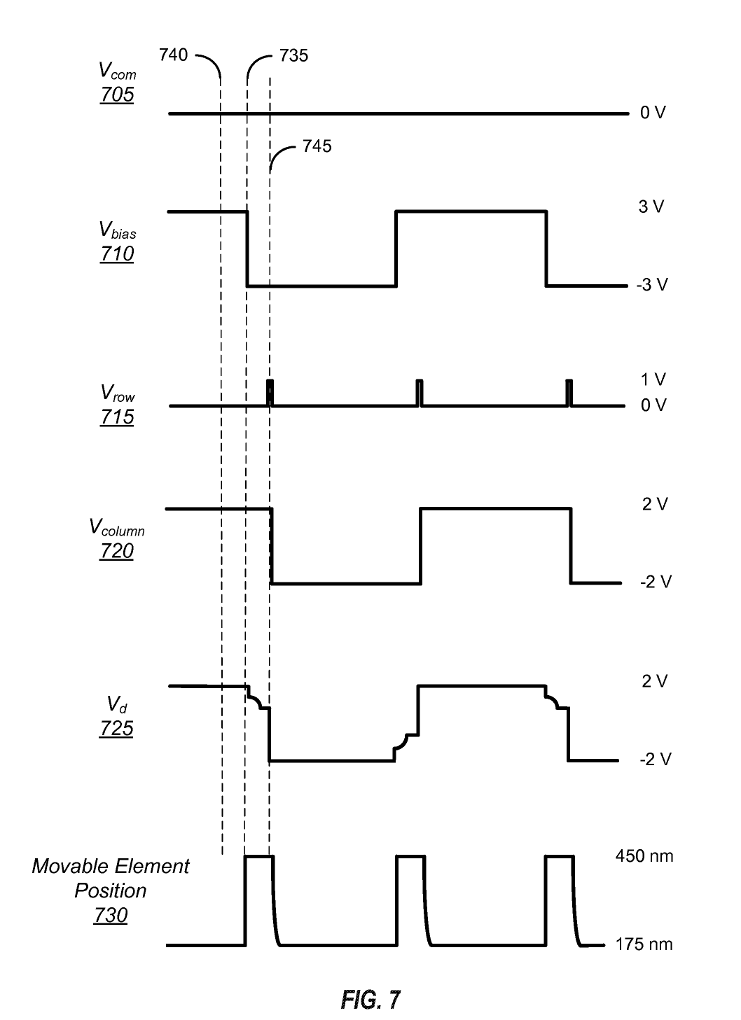

FIG. 7 is a timing diagram for the circuit schematic of FIG. 5. In FIG. 7, V_{com} 705 is associated with a power supply coupled with V_{com} electrode 565, and is biased at 0 V. V_{bias} 710 is associated with a power supply coupled with V_{bias} electrode 555. V_{bias} 710 toggles between 3 V and −3 V. V_{row} 715 is associated with V_{row} 540, and therefore, controls whether transistor M1 530 is turned on or off. V_{column} 720 is associated with V_{column} 520. V_{d} 725 is associated with V_{d} electrode 560. In an implementation, when M1 530 is turned on, V_{column} 720 is applied to V_{d} electrode 560.

The timing diagram of FIG. 7 illustrates reversing the polarity of V_{bias} relative to V_{com} to move movable element 570 to a consistent starting position or reset position. For example, at time 740, V_{bias} is 3 V, V_{d} is 2 V, and V_{com} is 0 V. Accordingly, the electric field between V_{bias} electrode 555 and V_{d} electrode 560 is pointed downward (i.e., from high potential to low potential). Likewise, the electric field between V_{d} electrode 560 and V_{com} electrode 565 is also pointed downward. The voltage difference between V_{bias} and V_{d} is 1 V. The voltage difference between V_{d} and V_{com} is 2 V.

However, at time 735, the polarity of V_{bias} is reversed by changing the voltage from a positive voltage (i.e., 3 V in FIG. 7) to a negative voltage (i.e., −3 V) and maintaining V_{com} at 0 V. Since V_{row} is low, transistor M1 510 is turned off, and therefore, V_{d} electrode 560 is floating, for example, at a previously applied 2 V rather than being driven by V_{column} 720. However, if capacitance C7 660 is sufficiently larger than capacitance C6 650, at time 735, V_{d} 725 may only slightly drop in voltage when V_{bias} switches polarity. For example, V_{d} 725 may change to 1.5 V from 2 V, due to the capacitor divider model, as previously discussed. Accordingly, the electric field between V_{d} electrode 560 and V_{com} electrode 565 remains relatively the same because V_{com} is constant at 0 V and V_{d} has only slightly dropped to 1.5 V (i.e., a 1.5 V difference between V_{d} and V_{com}) from 2 V. Additionally, the electric field remains pointing downward (i.e., from high to low potential). However, since V_{bias} has switched to −3 V from 3V, and V_{d} is at 1.5 V, the electric field between V_{bias} electrode 555 and V_{d} electrode 560 switches direction and points upward. Additionally, the voltage difference between V_{bias} electrode 555 and V_{d} electrode is 4.5 V (i.e., 4.5 V difference between V_{bias} at −3 V and V_{d} at 1.5 V). Accordingly, the electric field between V_{bias} and V_{d} (i.e., the electric field pointing upward) may be stronger than the electric field between V_{d} and V_{com} (i.e., the electric field pointing downward) because the voltage difference between V_{bias} electrode 555 and V_{d} electrode 560 (i.e., a 4.5 V difference) is much larger than the voltage difference between V_{d} electrode 560 and V_{com} electrode 565 (i.e., a 1.5 V difference). Therefore, movable element 570 may be pulled upwards by the stronger electric field. For example, in FIG. 7, movable element position 730 represents the position of movable element 570. At time 735, movable element 570 may be moved to the reset position (e.g., up to dielectric 575) at 450 nm.

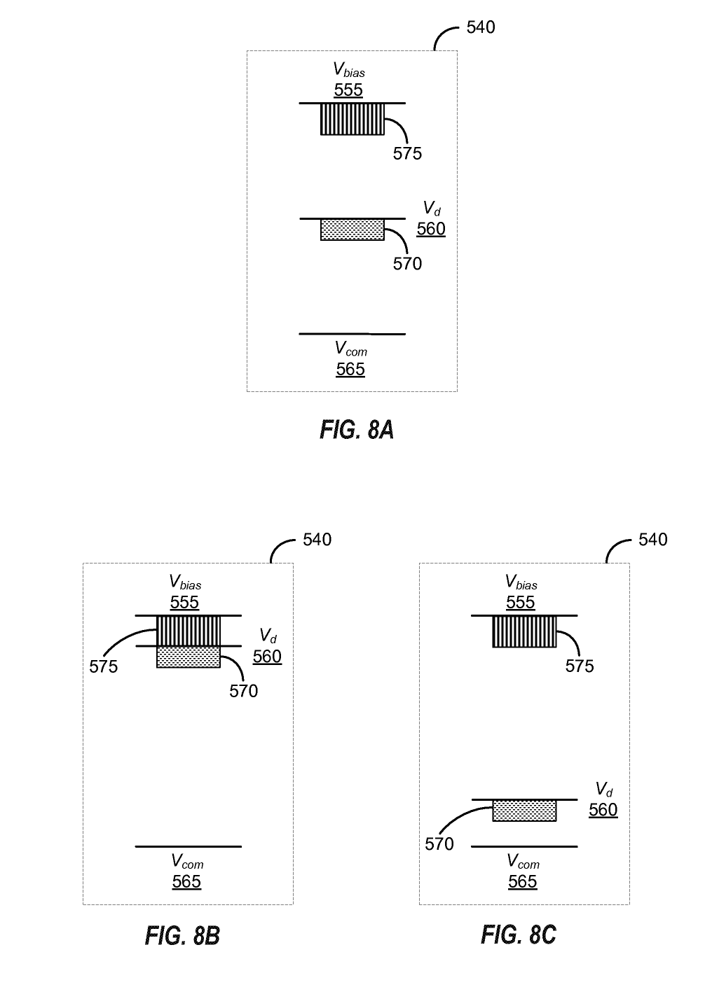

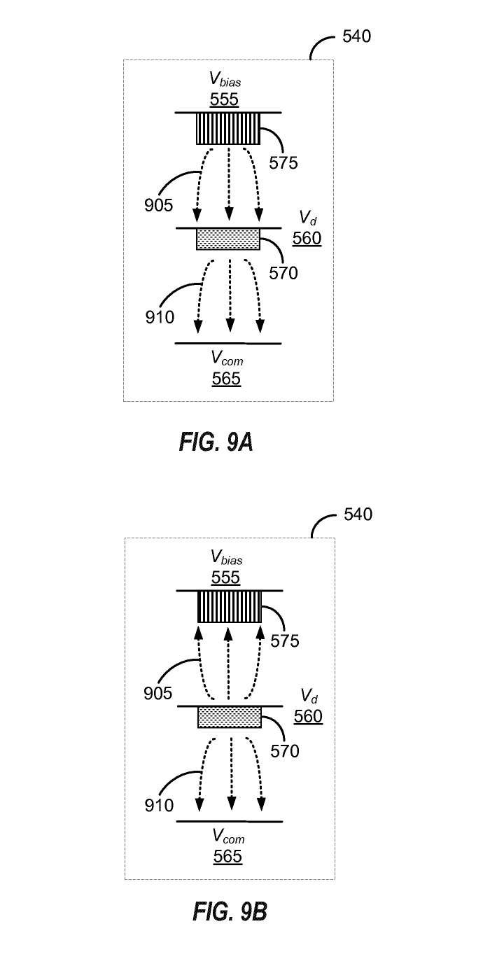

As an example, FIG. 8A is an illustration of an example of movable element 570 in a first position, for example, at time 740. FIG. 9A is an illustration of electric fields in the circuit schematic of FIG. 8, for example, at time 740. As previously discussed, electric field 905 (i.e., the electric field between V_{bias} electrode 555 and V_{d} electrode 560) and electric field 910 (i.e., the electric field between V_{d} electrode 560 and V_{com} electrode 565) both point downward, or towards V_{com} electrode 565. FIG. 8B is an illustration of an example of movable element 570 in a reset position, for example, at time 735. In FIG. 8B, movable element 570 has been pulled towards V_{bias} electrode 555 and rests against dielectric 575. As previously discussed, movable element 570 may be pulled towards V_{bias} electrode 555 because the electric field between V_{bias} electrode 555 and V_{d} electrode 560 (i.e., electric field 905) switches direction and points upward. For example, in FIG. 9B, at time 735, electric field 905 is stronger than the downward pointing electric field between V_{d} electrode 560 and V_{com} electrode 565 (i.e., electric field 910). In FIG. 9B, electric field 905 points upward rather than downward as in FIG. 9A. As previously discussed, the stronger and reversed electric field 905 may pull movable element 570 to the reset position in FIG. 8B.

After movable element 570 has been moved to the reset position, for example at time 740, movable element 570 may subsequently be moved to a new position. FIG. 8C is an illustration of an example of movable element 570 being moved to a new position at time 845. In FIG. 7, at time 745, V_{row} 715 goes high (i.e., to 1 V) and turns on transistor M1 510. Accordingly, V_{d} electrode 560 is no longer floating. Rather, V_{column} 720 is applied to V_{d} 725. As such, movable element 570 may move a distance from the reset position associated with an application of the voltage associated with V_{column} 720. For example, in FIG. 7, movable element position 730 at time 745 is associated with 175 nm. After movable element 570 has been set to the new position, V_{row} 715 goes low, and therefore, V_{d} electrode 560 is undriven and floating. Before moving movable element 570 to another position, movable element 570 may be moved back to the reset position (e.g., towards V_{bias} electrode 555).

In some implementations, both V_{bias} electrode 555 and V_{com} electrode 565 may change in voltage. For example, in one implementation, V_{bias} electrode 555 may switch from a positive to a negative voltage and V_{com} electrode 565 may switch from a negative to a positive voltage. In another implementation, the voltages applied to V_{com} electrode 565 and V_{bias} electrode 555 may both be positive voltages or both be negative voltages. For example, polarity may be reversed when one voltage increases while another voltage decreases. In another implementation, only V_{com} electrode 565 may change in voltage.

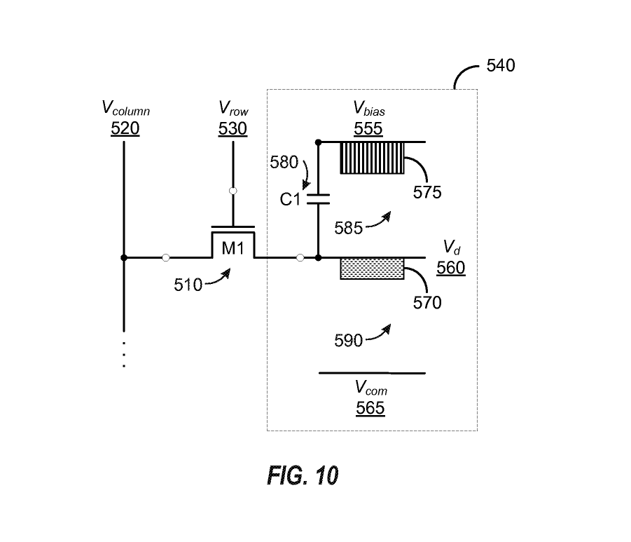

FIG. 10 is an example of another circuit schematic of a three terminal IMOD. In FIG. 10, capacitor C1 580 is coupled between V_{bias} electrode 555 and V_{d} electrode 560 rather than V_{d} electrode 560 and V_{com} electrode 565 as in FIG. 5. In the configuration of FIG. 10, movable element 570 may be moved to a reset position towards V_{com} electrode 565 rather than V_{bias} electrode 555 as in FIG. 5. That is, in FIG. 10, the electric field between V_{bias} electrode 555 and V_{d} electrode 560 may remain relatively unchanged and in the same direction, but the electric field between V_{d} electrode 560 and V_{com} electrode 565 may increase and switch direction, and therefore, pull movable element 570 towards V_{com} electrode 565. In some implementations, movable element 570 may rest against a dielectric.

Accordingly, in the circuit schematic of FIG. 10, the capacitance between V_{bias} electrode 555 and V_{d} electrode 560 is the equivalent capacitance of capacitor C1 580 in parallel with a series equivalent capacitance of air gap 585 and dielectric 875. The capacitance between V_{d} electrode 560 and V_{com} electrode 565 is the equivalent series capacitance of movable element 570 and air gap 590. If the capacitance between V_{bias} electrode 555 and V_{d} electrode 560 is sufficiently larger than the capacitance between V_{d} electrode 560 and V_{com} electrode 565, then the circuit of FIG. 10 operates similar to the circuit of FIG. 9. However, movable element 570 may be pulled downward rather than upward because capacitor C1 580 is coupled between V_{bias} electrode 555 and V_{d} electrode 560 rather than V_{d} electrode 560 and V_{com} electrode 565.

As previously discussed with FIG. 1, movable element 570 may include many layers, one layer being or including an electrode. In the circuit schematic of FIG. 5, V_{d} electrode 560 corresponds with a layer associated with a top portion of movable element 570.

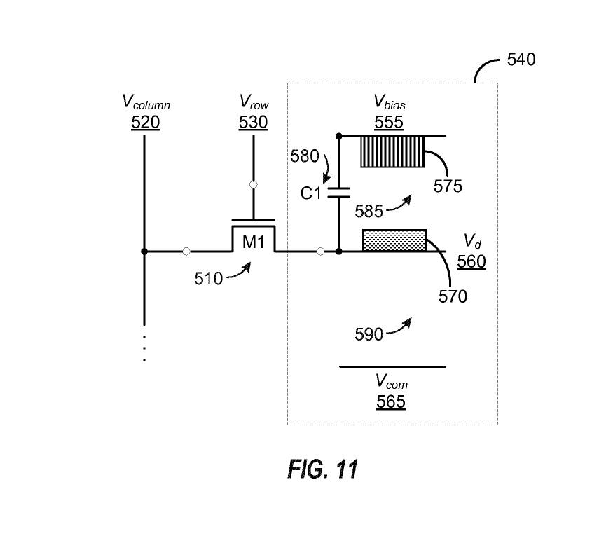

FIG. 11 is an example of another circuit schematic of a three terminal IMOD. In FIG. 11, V_{d} electrode 560 corresponds with a layer associated with a bottom portion of movable element 570 rather than a top portion as in FIG. 5. The top portion of movable element 570 may include a mirror. As such, the distance between V_{d} electrode 560 and V_{com} electrode 565 may be shorter than the distance between a mirror on another portion of movable element 570 and V_{com} electrode 565. Additionally, the capacitance between V_{bias} electrode 555 and V_{d} electrode 560 is the equivalent capacitance of capacitor C1 580 in parallel with a series equivalent capacitance of air gap 585, dielectric 575, and movable element 570. The capacitance between V_{d} electrode 560 and V_{com} electrode 565 is the capacitance of air gap 590.

In some implementations, as movable element 570 moves to a new position, certain instabilities may occur. For example, after movable element 570 has moved a certain distance, tip-in instability may occur due to rotational and translational properties of movable element 570, its hinge design and its movement mechanism. Movable element 570 may tilt, and therefore, movable element 570 may reflect light at different wavelengths rather than the desired wavelength that would be provided if movable element 570 was flat. When movable element 570 undergoes tip-in, a high voltage bias may need to be applied to “flatten” all of movable element 570. In some implementations, when tip-in instability occurs, approximately 50 V may need to be applied to movable element 570 such that it is re-oriented to be flat.

For example, movable element 570 may move towards V_{com} electrode 565. However, as movable element 570 travels towards V_{com} electrode 565, a tilt may occur, and therefore, a corner of movable element 570 may touch a dielectric layered above V_{com} electrode 565. However, a second corner of movable element 570 may not be touching the dielectric because movable element 570 is tilted. That is, an air gap may exist between the second corner and the dielectric. Accordingly, the second corner may be pulled towards the dielectric and close the air gap by biasing V_{d} electrode 560 with a high voltage. As such, both corners of movable element 570 may make contact with the surface of the dielectric.

Another example of instability is pull-in instability. In some implementations, as movable element 570 moves a certain distance, pull-in instability may occur. Once movable element 570 moves a certain distance, the mechanical restoring force of the mechanism to move movable element 570 (e.g., a hinge mechanism) may be weaker than the electrostatic force provided by the biasing of the various electrodes. Accordingly, movable element 570 “snaps” in to a slightly different position. However, unlike tip-in instability, movable element 570 may stay relatively flat when pull-in occurs.

In some implementations, the occurrence of pull-in instability and tip-in instability may be mutually exclusive. That is, if tip-in instability occurs, then pull-in instability may not occur, and vice versa. In some implementations, pull-in instability may occur before tip-in instability may occur, or vice versa. Accordingly, in some implementations, a design allowing pull-in instability rather than tip-in instability may be useful in applications where movable element 570 may need to be flat as it is moved to a new position.

In the circuit of FIG. 11, pull-in instability rather than tip-in instability may occur because V_{d} electrode 560 corresponds to a layer associated with a bottom portion, or the portion closer to V_{com} electrode 560, of movable element 570. Accordingly, as previously discussed, the capacitance between V_{d} electrode 560 and V_{com} electrode 565 is lower because it only includes air gap 590 rather than both air gap 590 and movable element 570. As such, less voltage may be needed to pull movable element 570 towards V_{com} electrode 565 and pull-in instability may occur before tip-in instability occurs.

Additionally, in some implementations, the size of air gap 585 may be reduced by driving movable element 870 from a bottom portion rather than a top portion. Additionally, dielectric layers associated with V_{bias} electrode 855 may also be thinner, allowing for easier and cheaper fabrication.

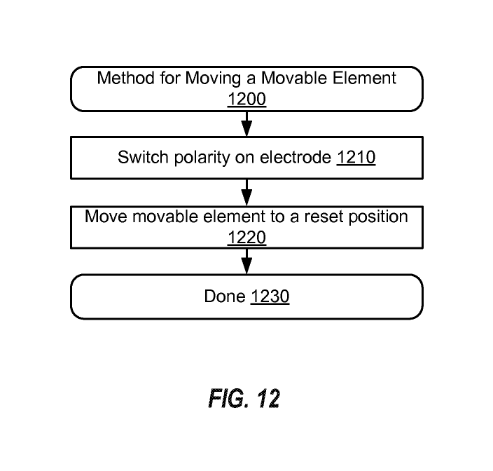

FIG. 12 is a flow diagram illustrating a method for moving a movable element to a reset position. In method 1200, at block 1210, the polarity of an electrode may be switched. For example, as previously discussed, the voltage on the electrode may change. In some implementations, the voltage on the electrode may be of an opposite polarity than that of another electrode. At block 1220, a movable element may be moved to a reset position. As previously discussed, the movable element may move towards the electrode. In some implementations, the movable element may rest against a dielectric when in the reset position. The method ends at block 1230.

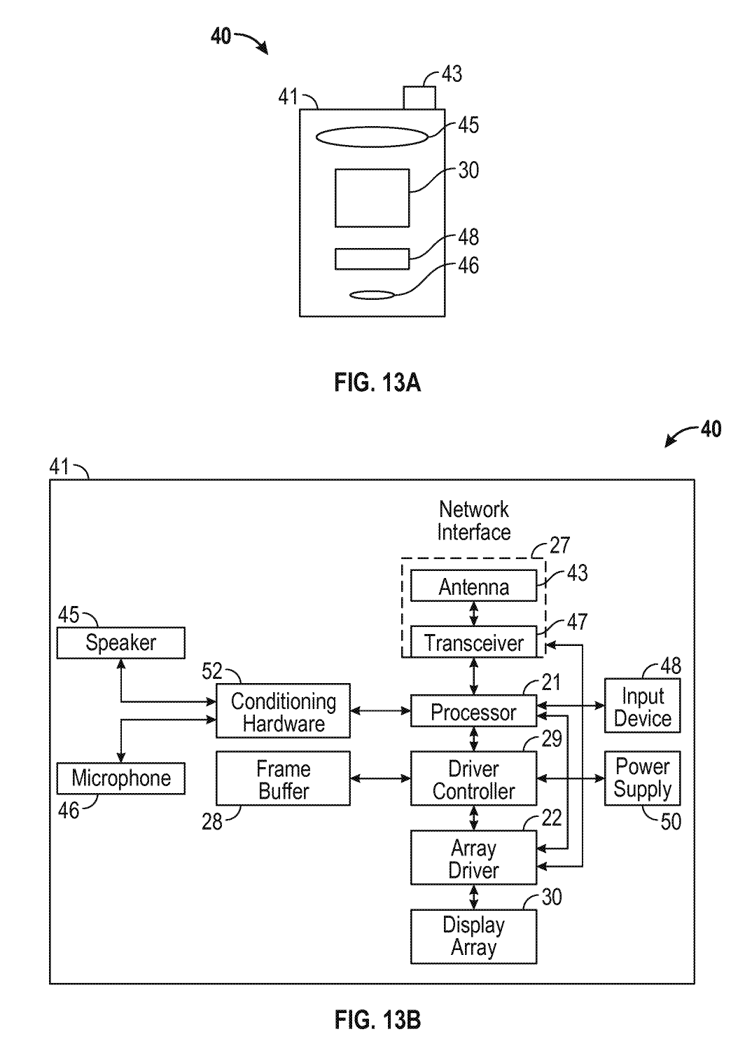

FIGS. 13A and 13B are system block diagrams illustrating a display device 40 that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 40 are schematically illustrated in FIG. 13A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 13A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

Though the circuits and techniques disclosed herein utilize an NMOS transistor, any other type of element with the functionality of a switch may be used. For example, PMOS transistors, bipolar junction transistors, memristors, and other components may be used. Depletion-type and enhancement-type PMOS and NMOS transistors may also be used.

Additionally, the circuits and techniques disclosed herein may be used in applications beyond positioning a movable element. The circuits and techniques may be employed in any scenario where positioning an object to a reset position may be beneficial.

The circuits and techniques disclosed herein utilize examples of values (e.g., voltages, capacitances, dimensions, etc.) that are provided for illustration purposes only. Other implementations may involve different values.

What is claimed is:

1. A circuit comprising:
a first electrode associated with a first voltage source;
a second electrode associated with a second voltage source;
a movable element;
a third electrode coupled with the movable element, wherein a first capacitance is defined between the first electrode and the third electrode, and wherein a second capacitance is defined between the second electrode and the third electrode; and
a capacitor coupled between the second electrode and the third electrode.

2. The circuit of claim 1, further comprising:
a dielectric positioned between the first electrode and the third electrode.

3. The circuit of claim 1, wherein the first voltage source and the second voltage source are configured to switch in polarity with reference to each other.

4. The circuit of claim 3, wherein an electric field associated with the first electrode and the third electrode changes direction responsive to the switch in polarity between the first voltage source and the second voltage source.

5. The circuit of claim 3, wherein the movable element is configured to move towards the first electrode responsive to the switch in polarity of the first voltage source.

6. The circuit of claim 1, wherein the second capacitance is larger than the first capacitance.

7. The circuit of claim 6, wherein the second capacitance is defined by a capacitance of the capacitor in parallel with an equivalent series capacitance of one or both of a first air gap and a dielectric.

8. The circuit of claim 7, wherein the first capacitance is defined by an equivalent series capacitance of one or both of a second air gap and the movable element.

9. The circuit of claim 6, wherein the second capacitance is defined by a capacitance of the capacitor in parallel with an equivalent series capacitance of one or both of a first air gap and the movable element.

10. The circuit of claim 9, wherein the first capacitance is defined by an equivalent series capacitance of one or both of a second air gap and a dielectric.

11. The circuit of claim 1, wherein the movable element includes the third electrode and a mirror.

12. The circuit of claim 11, wherein a first distance between the third electrode and the first electrode is smaller than a second distance between the mirror and the first electrode.

13. The circuit of claim 12, wherein the second capacitance is larger than the first capacitance.

14. The circuit of claim 13, wherein the second capacitance is defined by a capacitance of the capacitor in parallel with an equivalent series capacitance of a first air gap, the movable element, and a dielectric.

15. The circuit of claim 14, wherein the first capacitance is defined by a capacitance of a second air gap.

16. The circuit of claim 1, further comprising:
a display including a plurality of display elements;
a processor that is configured to communicate with the display, the processor being configured to process image data; and
a memory device that is configured to communicate with the processor.

17. The circuit of claim 16, further comprising:
a driver circuit configured to send at least one signal to the display; and
a controller configured to send at least a portion of the image data to the driver circuit.

18. The circuit of claim 16, further comprising:
an image source module configured to send the image data to the processor, wherein the image source module comprises at least one of a receiver, transceiver, and transmitter.

19. The circuit of claim 16, further comprising:
an input device configured to receive input data and to communicate the input data to the processor.

20. A circuit for moving a movable element of an electromechanical systems (EMS) device, comprising:
means for switching a polarity of a voltage source associated with an electrode; and
means for consistently resetting the movable element of the EMS device to the same reset position.

21. The circuit of claim 20, wherein the reset position is associated with a dielectric.

22. The circuit of claim 21, wherein the movable element rests against the dielectric when in the reset position.

23. A method for moving a movable element with a planar surface comprising:
switching a polarity of a voltage source associated with an electrode; and
moving the planar surface of the movable element towards the electrode in response to the switch in polarity of the first voltage source.

24. The method of claim 23, wherein the movable element is moved to a reset position associated with a dielectric.

25. The method of claim 24, wherein the movable element rests against the dielectric when in the reset position.
